(19) United States
(12) Patent Application Publication
(10) Pub. No.: US 2008/0255834 A1
(43) Pub. Date: Oct. 16, 2008

(54) Method and Device for Evaluating the Efficiency of a Noise Reducing Function for Audio Signals

(75) Inventors: Valerie Gautier-Turbin, Louannec (FR); Nicolas Le Faucheur, Rospez (FR)

Correspondence Address: COHEN, PONTANI, LIEBERMAN & PAVANE LLP, 551 FIFTH AVENUE, SUITE 1210, NEW YORK, NY, 10176, US

(73) Assignee: FRANCE TELECOM, Paris (FR)

(21) Appl. No.: 11/663,233

(22) PCT Filed: Sep. 12, 2005
(86) PCT No.: PCT/FR05/02262

§ 371 Date: Apr. 7, 2008

(30) Foreign Application Priority Data
Sep. 17, 2004 (FR) 0452087

(51) Int. Cl. G10L 21/02

(52) U.S. Cl. 704/226; 704/E21.001

(57) ABSTRACT

A method of evaluating the efficiency of a noise-reducing function adapted to be applied to audio signals and comprising a preliminary step of obtaining a predefined test audio signal X[m] containing a noise-free wanted signal, a noisy signal Xb[m] obtained by adding a predefined noise signal to the test signal X[m], and a processed signal Y[m], obtained by applying the noise-reducing function to the noisy signal Xb[m], is remarkable in that it includes a loudness measuring step (E3, E4) for some or all the frames m of the aforementioned signals X[m], Xb[m] and Y[m].

The present invention relates generally to noise-reducing functions applicable to audio signals.

More precisely, the invention relates to a method and a device for evaluating the efficiency of a noise-reducing function intended to be applied to audio signals.

The present invention aims in particular to characterize the performance of such a noise-reducing function as applied to speech signals.

In the field of audio signal transmission, the object of a noise-reducing function is to reduce the level of noise contained in a signal to improve the subjective quality of the reproduction of the signal as sound perceived by humans.

In the particular field of speech or voice signal transmission, a noise-reducing function applied to an input signal generally relies on a continuous estimation of the noise level present in the input signal (background noise or ambient noise during sending), on voice detection that enables frames of the input signal containing only noise to be distinguished from those containing speech (active speech frames), and on filtering the input signal to reduce the contribution of the noise in the signal.

It is important to be able to measure the efficiency of a noise-reducing function, in particular when it is a question of verifying that communications equipment including such functions and connected to a transmission network conforms to predefined voice quality specifications.

Known methods of evaluating the efficiency of a noise-reducing (NR) function rely on objective measurements to characterize the NR function concerned.

For example, one such method calculates the improvement in the signal-to-noise ratio (SNR) of a test signal before and after application of the noise-reducing function. That method is known as signal-to-noise ratio improvement (SNRI). For more information relating to said SNRI method, see the document “Draft Recommendation G.160 (voice enhancement devices)”, Appendix II, point 11.4—“Objective measures for characterization of NR algorithm effect”, ITU-T (International Telecommunication Union).

However, the performance of known methods of evaluating the efficiency of a noise-reducing (NR) function, such as the SNRI method, although they are indicative of the efficiency of a given noise-reducing function, are inadequate because, in characterizing its efficiency, they do not take into account human perception of the signal as processed by the NR function.

Unfortunately, it is known that, in addition to having the required effect of reducing the level of noise in an input signal, a noise-reducing function can also have the negative effect of simultaneously reducing the sound level of the wanted signal contained in the input signal.

In the context of audio signal transmission, the attenuation of the wanted signal (for example the voice signal) by the noise-reducing function may compromise the perception of the resulting audio signal as heard by the end user of the equipment reproducing the audio signal.

The present invention consequently aims to provide a method of evaluating a noise-reducing function, which method is of higher efficiency than known methods because it takes into account characteristics of human perception in the process of evaluating a noise-reducing function.

To this end, a first aspect of the invention provides a method of evaluating the efficiency of a noise-reducing function intended to be applied to audio signals, said method comprising a preliminary step of obtaining a predefined test audio signal X[m] containing a noise-free wanted signal, a noisy signal Xb[m] obtained by adding a predefined noise signal to the test signal X[m], and a processed signal Y[m] obtained by applying the noise-reducing function to the noisy signal Xb[m]. According to the invention, the method is remarkable in that it includes a loudness measuring step for some or all of the frames m of the aforementioned signals X[m], Xb[m] and Y[m].

Such a method of evaluating a noise-reducing function offers significantly better performance than the standard evaluation methods because it takes into account a characteristic relating to human auditory perception (loudness), calculated in particular from the test and processed signal frames.

The expression “psychoacoustic loudness” may be defined as the character of the auditory sensation linked to the sound pressure level and to the structure of the sound. In other words, it is a question of the sound force of a sound or a noise qua auditory sensation (cf. Office de la langue française, 1988). The loudness is represented by a psychoacoustic loudness scale (in units called sones). The loudness density, also called the “subjective intensity”, is one particular measurement of the loudness.

One preferred embodiment of the method according to the invention includes the following steps:

(a) calculating the mean loudness densities S̅_{X}(m_wanted) and S̅_{Y}(m_wanted) of each of the wanted signal frames “m_wanted” of the test signal X[m] and the processed signal Y[m], respectively, and the mean loudness densities S̅_{Xb}(m_noise) and S̅_{Y}(m_noise) of each of the noise frames “m_noise” of the noisy signal Xb[m] and the processed signal Y[m], respectively;

(b) calculating an index of efficiency IE of the noise-reducing function from the calculated mean loudness densities;

(c) comparing the calculated index of efficiency with at least one predetermined value of that index in order to determine a level of efficiency of the noise-reducing function.

According to a preferred implementation feature, the step (a) of calculating the mean loudness densities is followed by a step of calculating the mean values S̅_{Xb}_{_{—}}ₙₒᵢₛₑ, S̅_{Y}_{_{—}}ₙₒᵢₛₑ, S̅_{X}_{_{—}}_{wanted}, S̅_{Y}_{_{—}}_{wanted} of said mean loudness densities over all the frames concerned of each of the corresponding signals and wherein the index of efficiency IE is calculated using the following equation:

$$I E = β * \frac{{\overline{S}}_{Xb\_noise}}{{\overline{S}}_{Y\_noise}} with β = min ( 1 , \frac{{\overline{S}}_{Y\_wanted}}{{\overline{S}}_{X\_wanted}} )$$

The index of efficiency IE obtained in this way is used to combine an evaluation of the perception by the human ear of the noise reduction operative between the noisy signal Xb and the processed signal Y with an evaluation of the perception by the human ear of the attenuation of the level of the wanted signal in the processed signal Y (this effect is undesirable). This attenuation of the wanted signal is taken into account in calculating the index of efficiency, in particular through the contribution of the above coefficient β.

Unlike the known methods, an evaluation method according to the invention therefore takes into account the subjective perception by a human being of a reduction of the wanted signal level produced by the noise-reducing function.

In a preferred embodiment of the invention, in the above-mentioned step (a), the calculation of the mean loudness density S̅ᵤ(m) of any frame m of a given audio signal u includes the following steps:
windowing, for example of Hanning type, the frame m and obtaining a windowed frame u_w[m];
applying a Fourier transform to the windowed frame u_w[m] and obtaining a corresponding frame U(m,f) in the frequency domain;
calculating the power spectral density γ_{U}(m,f) of the frame U(m,f);
applying to the power spectral density γ_{U}(m,f) a conversion from the frequency axis to the Barks scale and obtaining a spectral power density B_{U}(m,b) on the Barks scale;
convoluting the spectral power density on the Barks scale B_{U}(m,b) with the spreading function and obtaining a spread spectral density E_{U}(m,b) on the Barks scale;
calibrating the spread spectral density E_{U}(m,b) on the Barks scale by the respective power scaling and loudness scaling factors;
converting the magnitude obtained in the preceding step to the phons scale and then converting the magnitude previously converted into phons to the sones scale and consequently obtaining a number B of loudness density values S_{U}(m,b) of the frame m for the critical band b, where B is the number of critical bands concerned on the Barks scale and the index b varying from 1 to B;
calculating the mean loudness density S̅_{U}(m) of any frame m from said B loudness density values S̅_{U}(m,b) using the following equation:

$${\overline{S}}_{U} ( m ) = \frac{1}{B} {\sum }_{b = 1}^{B} {S}_{U} ( m , b )$$

A second aspect of the invention provides test equipment adapted to evaluate the efficiency of a noise-reducing function. According to the invention this equipment includes means adapted to implement a method as described above.

The present invention also provides a computer program on an information medium, the program including instructions adapted to implement a method according to the invention when the program is loaded into and executed in an electronic data processing system.

The advantages of this equipment or this computer program are identical to those indicated above in relation to the method of the invention.

The invention can be better understood on reading the following detailed description, given by way of example only and with reference to the drawings, in which:

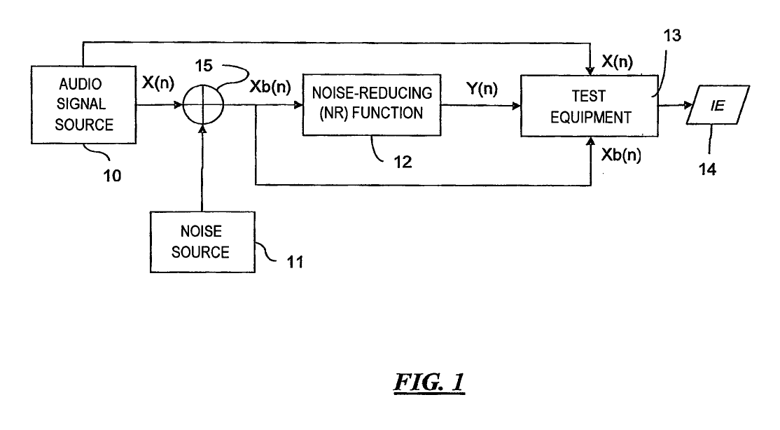

FIG. 1 represents a test environment for evaluating a noise-reducing function in accordance with the present invention;

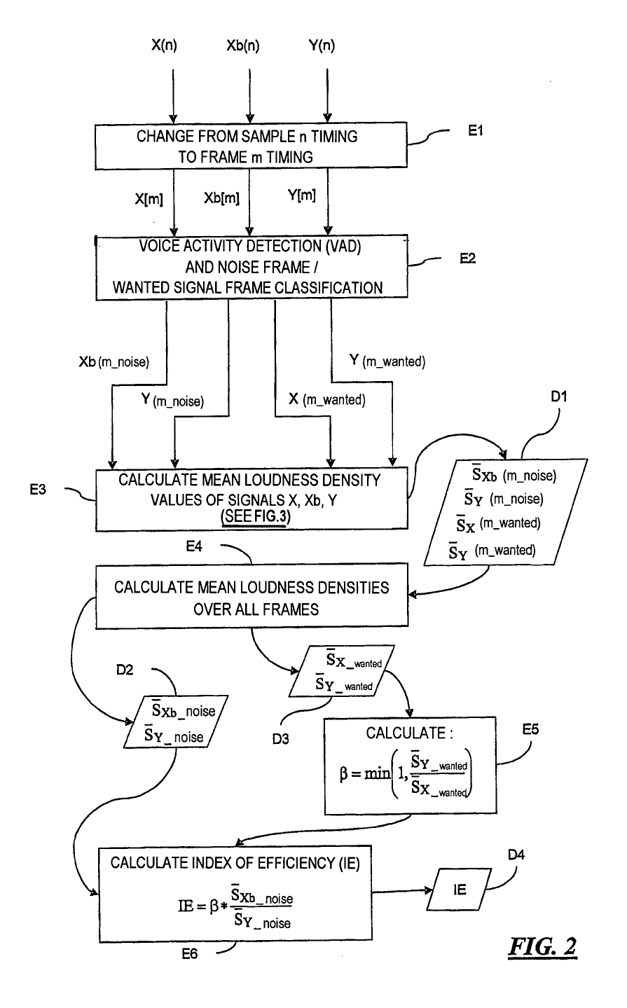

FIG. 2 is a flowchart showing one method of evaluating the efficiency of a noise-reducing function in accordance with the invention; and

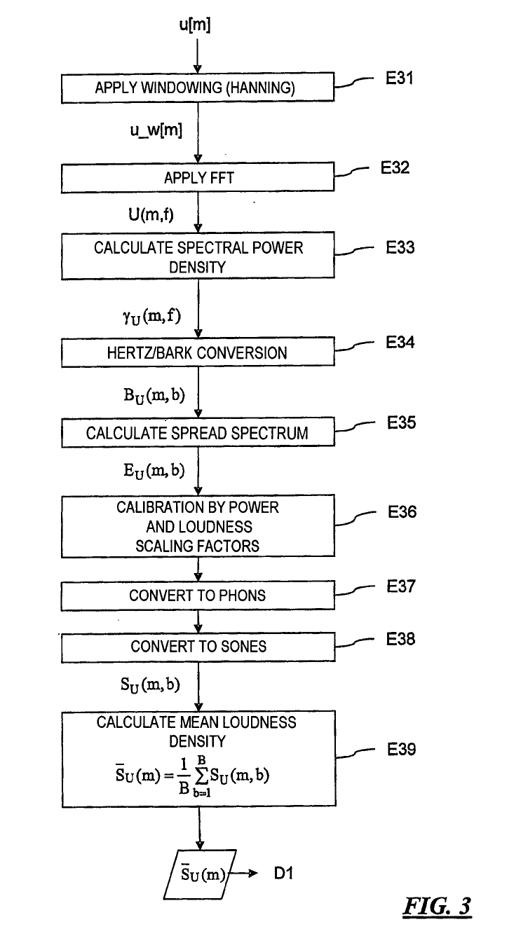

FIG. 3 is a flowchart showing the method of calculating the mean loudness density of a frame of an audio signal in accordance with one preferred embodiment of the invention.

FIG. 1 shows a test environment in which the present invention may be implemented to evaluate a noise-reducing function.

As shown in FIG. 1, such a test environment comprises an audio signal source 10 delivering audio signals X(n) containing only wanted (noise-free) signals, for example speech signals, and a noise source 11 delivering predefined noise signals.

For test purposes, a predefined contribution of noise is added to the chosen test signal X(n), as represented by the addition operator 15. The audio signal Xb(n) resulting from this addition of noise to the test signal X(n) is called the “noisy signal”.

The noisy signal Xb(n) then constitutes the input signal of a noise-reducing (NR) module 12 implementing the noise-reducing function whose efficiency is to be evaluated in accordance with the invention.

The noise-reducing module 12 delivers an output audio signal Y(n) processed by the noise-reducing algorithm used and called the “processed signal”.

The processed signal Y(n) is then delivered to a test equipment 13 implementing an evaluation method according to the invention. In addition to the signal Y(n), the test equipment 13 receives as input the test signal X(n) and the noisy signal Xb(n).

The test equipment 13 according to the invention finally delivers at its output an evaluation result 14 in respect of the noise-reducing function.

In practice, in a preferred embodiment, this evaluation result consist of the value of an index of efficiency (IE) the method of calculating which is described below.

The aforementioned audio signals X(n), Xb(n) and Y(n) are sampled signals in a digital format (n designating any sample).

In practice the test equipment 13 includes hardware (electronic) means and/or software means adapted to implement an evaluation method according to the invention.

In a preferred embodiment, the steps of the evaluation method of the invention are determined by the instructions of a computer program executed in such test equipment.

Thus the method according to the invention is implemented when the aforementioned program is loaded into electronic data processing means incorporated in the test equipment, with the operation thereof then being controlled by executing the program.

Here “computer program” means one or more computer programs forming a (software) set the objective of which is to implement the invention when it is executed by an appropriate electronic data processing system.

Consequently, the invention also consist in such a computer program, in particular in the form of software stored on an information medium, which may consist of any entity or device capable of storing a program in accordance with the invention.

For example, the medium in question may include hardware storage means, such as a ROM, for example a CD ROM or a microelectronic circuit ROM, or a magnetic recording medium, for example a hard disk. Alternatively, the information medium may be an integrated circuit into which the program is incorporated, the circuit being adapted to execute the method in question or to be used in its execution.

The information medium may also be a transmissible non-material medium, such as an electrical or optical signal that can be routed via an electrical or optical cable, by radio, or by other means. A program according to the invention may in particular be downloaded over an Internet-type network.

From a design point of view, a computer program according to the invention may use any programming language and be in the form of source code, object code or an intermediate code between source code and object code (for example it may be in a partially compiled form), or in any other form desirable for implementing a method according to the invention.

The method according to the present invention of evaluating the efficiency of a noise-reducing function is described in more detail next with reference to FIGS. 2 and 3.

As represented in FIG. 2, the test audio signal X(n), the noisy test signal Xb(n), and the signal Y(n) processed by the noise-reducing function are obtained beforehand and received as input by the test equipment 13 mentioned above (FIG. 1).

In the embodiment described and shown here; the test signal X(n) is a noise-free speech signal. The noisy signal Xb(n) represents the initial voice signal X(n) degraded by a noisy environment (background noise or ambient noise) and the signal Y(n) represents the signal Xb(n) after noise reduction.

In one embodiment of the invention, the signal X(n) is generated in an anechoic chamber. However, the signal X(n) may also be generated in a “quiet” room having a “moderate” reverberation time (less than 0.5 seconds).

The noisy signal Xb(n) is obtained by adding a predetermined contribution of noise to the signal X(n). The signal Y(n) is obtained either as output from a noise-reducing algorithm installed on a personal computer (PC) or as output from a noise reducer (network equipment), with the signal Y(n) then being obtained from a pulse code modulation (PCM) coder.

Referring to FIG. 2, during an initial step E1, the aforementioned signals are respectively divided into successive time windows called frames. Each signal frame, denoted m, contains a predetermined number of samples of the signal, and the step E1 therefore changes the timing of each of these signals.

In a second step E2, the signals X[m], Xb[m], Y[m] resulting from the frame timing change are subjected to voice activity detection (VAD) to determine if each respective current frame m of these signals is a frame containing only noise (“noise frame”) or a frame containing speech (“wanted signal frame”). Following the step E2, each of the frames of these signals is classified either as a noise frame or as a wanted signal frame, i.e. a speech frame.

As represented in FIG. 2, following the step E2 four types of frame are selected from the signals X[m], Xb[m], Y[m]:
the noise frames of the noisy signal Xb[m], denoted Xb[m_noise];
the noise frames of the processed signal Y[m], denoted Y[m_noise];
the active speech (wanted signal) frames of the test signal X[m], denoted X[m_wanted];
the active speech frames of the processed signal Y[m], denoted Y[m_wanted].

The next step E3 is a loudness measuring step of some or all of the frames of the signals X[m], Xb[m] and Y[m].

More precisely, in this step, the respective mean loudness densities S̅_{X}(m_wanted) and S̅_{Y}(m_wanted) of each wanted signal frame “m_wanted” of the test signal X[m] and the processed signal Y[m] are calculated, and the respective mean loudness densities S̅_{Xb}(m_noise) and S̅_{Y}(m_noise) of the noise frames “m_noise” of the noisy signal Xb[m] and the processed signal Y[m] are calculated.

The calculation of a mean loudness density S̅_{U}(m) of any frame m of a given audio signal u will be described in detail later with reference to FIG. 3.

Thus following the step E3 there is therefore obtained a set D1 of mean loudness density values.

In the next step E4, the mean values S̅_{Xb}_{_{—}}ₙₒᵢₛₑ, S̅_{Y}_{_{—}}ₙₒᵢₛₑ, S̅_{X}_{_{—}}_{wanted}, S̅_{Y}_{_{—}}_{wanted} of the mean loudness densities mentioned above are calculated over all the frames concerned (noise frames or speech frames) of each of the corresponding signals (X[m], Y[m] or Xb[m]).

There are then obtained, firstly, a first pair D2 of mean values S̅_{Xb}_{_{—}}ₙₒᵢₛₑ and S̅_{Y}_{_{—}}ₙₒᵢₛₑ of the mean loudness densities corresponding to the noise frames of the noisy signal (Xb) and the processed signal (Y) and, secondly, a second pair D3 of mean values S̅_{X}_{_{—}}_{wanted} and S̅_{Y}_{_{—}}_{wanted} of the mean loudness densities corresponding to the active speech frames of the test signal (X) and the processed signal (Y).

Then, in the step E5, the pair D3 of mean values of the mean loudness densities is used to calculate a coefficient β using the following formula:

$$β = min ( 1 , \frac{{\overline{S}}_{Y\_wanted}}{{\overline{S}}_{X\_wanted}} )$$

The coefficient β is therefore obtained by determining which has the lower value (minimum function—min):the digit “1” or the ratio of the mean value S̅_{Y}_{_{—}}_{wanted} of the mean loudness densities of the speech frames of the signal Y processed by the noise-reducing function to the mean value S̅_{X}_{_{—}}_{wanted} of the mean loudness densities of the speech frames of the test signal X.

The coefficient β is indicative of the attenuation, as perceived by the human ear, of the wanted signal (active speech signal) caused by the application of the noise-reducing function to the noisy signal (Xb).

Referring again to FIG. 2, in the step E6, the pair D2 of mean values S̅_{Xb}_{_{—}}ₙₒᵢₛₑ and S̅_{Y}_{_{—}}ₙₒᵢₛₑ of the mean loudness densities corresponding to the noise frames of the noisy signal (Xb) and the processed signal (Y) are used conjointly with the coefficient β calculated in the step E5 to calculate the index of efficiency IE from the following formula:

$$I E = β * \frac{{\overline{S}}_{Xb\_noise}}{{\overline{S}}_{Y\_noise}} where β = min ( 1 , \frac{{\overline{S}}_{Y\_wanted}}{{\overline{S}}_{X\_wanted}} )$$

in which * symbolizes the multiplication operator in the space of real numbers.

Thus, according to the index of efficiency IE of the invention, the subjective perception by the human ear of the noise reduction effected on the noisy signal (Xb) (resulting signal Y) and “measured” by the ratio

$$\frac{{\overline{S}}_{Xb\_noise}}{{\overline{S}}_{Y\_noise}}$$

is weighted by the coefficient β that is indicative of the subjective perception by the human ear of the attenuation of the wanted signal in the signal (Y) resulting from the processing by the noise-reducing function.

In the embodiment described, the (decimal) value of this index is then converted into decibels (dB) and is then saved (D4) so that it can be used to characterize the efficiency of the noise-reducing function.

To this end, the value of the index IE obtained (D4) is compared with at least one predetermined value of that index in order to determine a level of efficiency of the noise-reducing function.

In the embodiment described, the level of efficiency of the noise-reducing (NR) function is determined from the following table:

| IE | Efficiency |
|---|---|
| (dB) | of NR function |
| >4 | Good |
| 2.5-4 | Moderate |
| 1-2.5 | Weak |
| 0-1 | Very weak |

Thus, according to the above table, if the index of efficiency IE is from 2.5 dB to 4 dB, the efficiency of the noise-reducing function is judged “moderate”.

In an example of the use of the invention for validating the evaluation method according to the invention, the index of efficiency IE was calculated from an audio signal database also tested subjectively in accordance with Recommendation P.835 of the ITU-T (International Telecommunication Union—Telecommunications standardization sector). The variation of the value of the index IE obtained as a function of the audio signals from the database was judged to conform to the subjective test results.

A mean loudness density calculation for an audio signal frame according to a preferred embodiment of the invention is described next with reference to FIG. 3.

According to the flowchart represented in FIG. 3, the calculation in accordance with the invention of the mean loudness density S̅_{U}(m) of any frame m of a given audio signal u[m] comprises the steps described below.

Any frame m of a signal u[m] is considered below, given that some or all of the frames of the signal concerned undergo the same treatment. The signal u[m] represents any of the signals X[m], Xb[m], Y[m] defined above.

In the first step, E31, windowing is applied to the frame m of the signal u[m], for example Hanning, Hamming or equivalent type windowing. A windowed frame u_w[m] is then obtained.

In the next step E32 a fast Fourier transform (FFT) is applied to the windowed frame u_w[m] and a corresponding frame U(m,f) in the frequency domain is therefore obtained.

In the step E33, the power spectral density γ_{U}(m,f) of the frame U(m,f) is calculated. This calculation is known to the person skilled in the art and is therefore not described in detail here.

In the next step, E34, there is applied to the power spectral density γ_{U}(m,f) obtained in the preceding step a conversion from the frequency axis to the Barks scale, and a power spectral density B_{U}(m,b) on the Barks scale is therefore obtained. This type of conversion is known to the person skilled in the art, the principle of this Hertz/Bark conversion consisting in adding all the frequency contributions present in the critical band concerned of the Barks scale.

Then, in the step E35, a convolution with the spreading function is applied to the power spectral density on the Barks scale B_{U}(m,b) and a spread spectral density on the Barks scale is therefore obtained, denoted E_{U}(m,b). This step makes it possible to take into account the interaction of adjacent critical bands.

In the step E36, the spread spectral density is calibrated on the Barks scale E_{U}(m,b) by the respective power scaling and loudness scaling factors. Sections 10.2.1.3 and 10.2.1.4 of ITU-T Recommendation P.862 give an example of this kind of calibration for the aforementioned factors.

The magnitude obtained in the preceding step is then converted to the phons scale (step E37). The conversion to the phons scale is effected using the curves of equal loudness (Fletcher curves) conforming to the standard NF ISO 226 “Normal equal-loudness-level contours”.

The magnitude previously converted into phons is then converted to the sones scale (step E38). The conversion into sones is effected in accordance with Zwicker's law whereby:

$$N ( sones ) = {2}^{( \frac{N ( phons ) - 40}{10} )}$$

For more information on phon/sone conversion, see “PSYCHOACOUSTIQUE, L'oreille récepteur d'information”, E. Zwicker and R. Feldtkeller, Masson, 1981. [translation of title: “PSYCHOACOUSTICS, The information-receiving ear”].

Following the step E38 a number B of loudness density values S_{U}(m,b) of the frame m for the critical band b is available, B being the number of critical bands considered on the Barks scale and the index b varying from 1 to B.

For example, if the sampling frequency Fe of the signal u(n) concerned is equal to 8 kHz (kiloHertz), 18 critical bands are considered on the Barks scale.

Finally, in the step E39, the mean loudness density S̅_{U}(m) of any frame m is calculated from said B loudness density values, using the following equation:

$${\overline{S}}_{U} ( m ) = \frac{1}{B} {\sum }_{b = 1}^{B} {S}_{U} ( m , b )$$

In other words, the mean loudness density S̅_{U}(m) according to the invention of a frame m is therefore the mean of the B loudness density values S_{U}(m,b) of the frame m for the critical band b concerned.

Following the step E39, each mean loudness density value is saved so that it can be used in the method in accordance with the invention of evaluating a noise-reducing function (cf. FIG. 2, D1).

Although in the embodiment described above the audio signals are speech signals, the present invention can be used to evaluate the efficiency of any noise-reducing function applying to audio signals in the generic sense of the term.

1. A method of evaluating the efficiency of a noise-reducing function intended to be applied to audio signals, said method comprising a preliminary step of obtaining a predefined test audio signal X[m] containing a noise-free wanted signal, a noisy signal Xb[m] obtained by adding a predefined noise signal to the test signal X[m], and a processed signal Y[m] obtained by applying the noise-reducing function to the noisy signal Xb[m], the method including a loudness measuring step for some or all of the frames m of said signals X[m], Xb[m], and Y[m].

2. A method according to claim 1, comprising the steps of:
(a) calculating the mean loudness densities S̅_{X}(m_wanted) and S̅_{Y}(m_wanted) of each of the wanted signal frames “m_wanted” of the test signal X[m] and the processed signal Y[m], respectively, and the mean loudness densities S̅_{Xb}(m_noise) and S̅_{Y}(m_noise) of each of the noise frames “m_noise” of the noisy signal Xb[m] and the processed signal Y[m], respectively;
(b) calculating an index of efficiency IE of the noise-reducing function from the calculated mean loudness densities; and
(c) comparing the calculated index of efficiency with at least one predetermined value of that index in order to determine a level of efficiency of the noise-reducing function.

3. A method according to claim 2, wherein the step (a) of calculating the mean loudness densities is followed by a step of calculating mean values S̅_{Xb}_{_{—}}ₙₒᵢₛₑ, S̅_{Y}_{_{—}}ₙₒᵢₛₑ, S̅_{X}_{_{—}}_{wanted}, S̅_{Y}_{_{—}}_{wanted} of said mean loudness densities over all the frames concerned of each of the corresponding signals, and wherein the index of efficiency IE is calculated using the following equation:
$$I E = β * \frac{{\overline{S}}_{Xb\_noise}}{{\overline{S}}_{Y\_noise}} with β = min ( 1 , \frac{{\overline{S}}_{Y\_wanted}}{{\overline{S}}_{X\_wanted}} )$$

4. A method according to claim 3, wherein the noise-reducing function is intended to be applied to audio signals containing a wanted signal comprising a speech signal, said test signal X[m] being a noise-free speech signal, and wherein said step of calculating mean loudness densities is preceded by a step of detecting voice activity applied to the signals X[m], Xb[m], Y[m] to determine if each respective current frame m of those signals is a frame containing only noise (“noise frame”) or a frame containing speech (“wanted signal frame”).

5. A method according to claim 4, wherein, in the step (a), the calculation of the mean loudness density S̅_{U}(m) of any frame m of a given audio signal u includes the following steps:
windowing, for example of Hanning type, the frame m and obtaining a windowed frame u_w[m];
applying a Fourier transform to the windowed frame u_w[m] and obtaining a corresponding frame U(m,f) in the frequency domain;
calculating the power spectral density γ_{U}(m,f) of the frame U(m,f);
applying to the power spectral density γ_{U}(m,f) a conversion from the frequency axis to the Barks scale and obtaining a spectral power density B_{U}(m,b) on the Barks scale;
convoluting the power spectral density on the Barks scale B_{U}(m,b) with the spreading function and obtaining a spread spectral density E_{U}(m,b) on the Barks scale;
calibrating the spread spectral density E_{U}(m,b) on the Barks scale by the respective power scaling and loudness scaling factors;
converting the magnitude obtained in the preceding step to the phons scale and then converting the magnitude previously converted into phons to the sones scale and consequently obtaining a number B of loudness density values S_{U}(m,b) of the frame m for the critical band b, where B is the number of critical bands concerned on the Barks scale and the index b varying from 1 to B; and
calculating the mean loudness density S̅_{U}(m) of any frame m from said B loudness density values S_{U}(m,b) using the following equation:
$${\overline{S}}_{U} ( m ) = \frac{1}{B} {\sum }_{b = 1}^{B} {S}_{U} ( m , b )$$

6. Test equipment adapted to evaluate the efficiency of a noise-reducing function, said test equipment including means adapted to implement a method according to claim 1.

7. The test equipment according to claim 6, including electronic data processing means and a computer program, said program including instructions adapted to implement said method when it is executed by said electronic data processing means.

8. A computer program on an information medium, said program including instructions adapted to implement a method according to claim 1 when the program is loaded into and executed in an electronic data processing system.
